(19) United States
(12) Patent Application Publication
(10) Pub. No.: US 2026/0112855 A1
(43) Pub. Date: Apr. 23, 2026

(54) MOTOR TURNTABLE BARRIER-FREE ELECTRICAL-CONDUCTION STRUCTURE

(71) Applicant: Yung-Chen HSU, New Taipei City (TW)

(72) Inventor: Yan LIU, Dongguan (CN)

(73) Assignee: Yung-Chen HSU, New Taipei City (TW)

(21) Appl. No.: 18/920,380

(22) Filed: Oct. 18, 2024

(51) Int. Cl. H01R 39/64; B65G 29/00

(52) U.S. Cl. CPC H01R 39/64; B65G 29/00

(57) ABSTRACT

A motor turntable barrier-free electrical-conduction structure includes: a base with a drive motor; and a rotating platform disposed on the base and driven by the drive motor to rotate about a central axis on the base. At least one positioning groove concentric about the central axis is disposed on the rotating platform circumferentially and faces one side of the base. At least one pair of concentric electrically-conductive rings are disposed on the rotating platform and fixed in the positioning groove. The base has at least one resilient plate holder inserted into the positioning groove. At least one pair of electrically-conductive resilient plates are fixed to the resilient plate holder. The electrically-conductive rings rotate together with the rotating platform. The electrically-conductive resilient plates continuously abut against the electrically-conductive rings through the resilient arms to form circuit conduction, allowing electricity to be freely transmitted from the base to the rotating platform.

### BACKGROUND OF THE INVENTION

### 1. Technical Field

The present disclosure relates to turntable structures driven by rotary motors, and more particularly to a motor turntable barrier-free electrical-conduction structure for allowing electricity to be freely transmitted from a base to a rotating platform while a turntable is rotating.

### 2. Description of Related Art

Conventional, frequently used rotary motor turntables each usually comprise a stator and a rotor which coordinate with each other, and comprise a base or a frame for fixing a rotary motor in place to form the stator, and directly output transmission to a turntable or indirectly output transmission to the turntable to form the rotor to achieve turntable structures driven by rotary motors.

However, owing to restrictions related to demand and cost, conventional rotary motor turntables are not provided in the form of products that allow electricity to be transmitted from an underlying base to a rotating platform, failing to meet the electricity consumption need of installed electronic products. Therefore, it is imperative to overcome the aforesaid drawback of conventional motor turntables and provide a motor turntable barrier-free electrical-conduction structure capable of achieving electrical conduction freely, durable, and multifunctional.

### BRIEF SUMMARY OF THE INVENTION

It is an objective of the disclosure to provide a motor turntable barrier-free electrical-conduction structure comprising a base with resilient plate holders capable of being inserted into and corresponding in position to positioning grooves disposed on a rotating platform and adapted to fix electrically-conductive rings in place to not only appropriately fix electrically-conductive resilient plates and the electrically-conductive rings in place but also allow the electrically-conductive resilient plates to steadily and continuously abut against the electrically-conductive rings rotating together with the rotating platform and thereby form uninterrupted circuit conduction, allowing electricity to be transmitted from the base to the rotating platform steadily and freely.

To achieve the above and other objectives, the disclosure provides a motor turntable barrier-free electrical-conduction structure comprising: a base with a drive motor; and a rotating platform disposed on the base and driven by the drive motor to rotate about a central axis on the base. The rotating platform comprises a lower rotating disk and an upper disk cover coupled together, and a platform surface which an object can be placed on is formed on top of the upper disk cover, allowing at least one pair of concentric electrically-conductive rings and at least one ring-shaped positioning groove concentric relative to the central axis to be disposed on the lower rotating disk and face the base, allowing the pair of electrically-conductive rings to abut against and be fixed to an inner wall and an outer wall of the positioning groove respectively, with the electrically-conductive rings each extending upward to form at least one upper connection end disposed penetratingly at the lower rotating disk and disposed between the lower rotating disk and the upper disk cover to electrically connect to a power output portion of the rotating platform. At least one resilient plate holder corresponding in position to the positioning groove and inserted into the positioning groove and at least one pair of electrically-conductive resilient plates are disposed at the base. A resilient plate slot for fixing the electrically-conductive resilient plates in place are disposed on each of two sides of the resilient plate holder respectively, with the two sides facing the inner wall and the outer wall of the positioning groove respectively. The electrically-conductive resilient plates each comprise a body fixed in place in a corresponding one of the resilient plate slots and at least one resilient arm resiliently abutting against a corresponding one of the electrically-conductive rings. The body has a lower connection end electrically connected to a power supply portion of the base. Therefore, the at least one pair of electrically-conductive rings rotate together with the rotating platform while the rotating platform is rotating on the base, and the at least one pair of electrically-conductive resilient plates continuously abut against the electrically-conductive rings through the resilient arms respectively to form circuit conduction, allowing electricity to be freely transmitted from the base to the rotating platform.

The base has the two resilient plate holders and the two pairs of electrically-conductive resilient plates which correspond in position to the positioning grooves, and the two resilient plate holders are disposed on two opposing sides of the central axis respectively. Therefore, the electrically-conductive rings each correspond in position to and abut against a plurality of electrically-conductive resilient plates to form more electrical-conduction loops to ensure conduction stability.

The electrically-conductive rings are made of electrically-conductive sheets bent to become ring-shaped and concentric, and the electrically-conductive rings extend upward to form a plurality of upper connection ends electrically connected to a power output portion, increasing the electrical-conduction loops in the rotating platform to ensure the stability of circuit conduction.

In a feasible embodiment, the drive motor comprises an output rotating shaft disposed at the central axis, allowing the output rotating shaft to drive the rotating platform directly. Alternatively, the drive motor is disposed beside the central axis, and a transmission mechanism is connected to the rotating platform, driving the rotating platform indirectly.

Given the aforesaid indirectly driving structure, the drive motor is disposed beside the central axis and comprises an output rotating shaft and a drive gear disposed on the output rotating shaft, with the drive gear meshing with a wheel at a bottom of the lower rotating disk, allowing the drive motor to drive the drive gear rotating and thereby cause the wheel to drive the rotating platform rotating.

The base has a hollow-core passage at the central axis and an axial bearing unit annularly disposed around the hollow-core passage and adapted to abut against the lower rotating disk of the rotating platform to enable the rotating platform to rotate about the central axis on the base. The lower rotating disk and the upper disk cover of the rotating platform each have a hollowed-out central hole corresponding in position to the hollow-core passage.

The base comprises an underlying bottom casing and an intermediate casing disposed between the bottom casing and the rotating platform. The bottom casing and the intermediate casing each have a hollow-core tube corresponding in position to the central axis, and the two hollow-core tubes are in communication with each other to form the hollow-core passage.

The base has a partition corresponding in position to the intermediate casing and adapted to divide internal space of the base to form the intermediate casing internal space (the partition is equivalent to a bottom board of the intermediate casing) and the bottom casing internal space. The bearing unit, the resilient plate holders and the drive gear are disposed above the partition and in the intermediate casing. The drive motor is disposed below the partition and in the bottom casing. The output rotating shaft of the drive motor penetrates the partition to connect to and drive the drive gear.

The bodies of the electrically-conductive resilient plates extend downward to form the lower connection ends, with the lower connection ends penetrating the partition below and disposed in the space below the partition or the bottom casing internal space. In the space below the partition or in the bottom casing, the power supply portion is electrically connected to the lower connection ends and the drive motor.

In a preferred embodiment, a plurality of spaced-apart ball positioning portions surround the bearing unit in the intermediate casing and each receive a ball abutting against a bottom surface of the lower rotating disk and coordinating with the bearing unit to abut against the rotating platform and share the load of the bearing unit to enable the rotating platform to rotate about the central axis on the base smoothly and steadily.

In a preferred embodiment, the lower rotating disk of the rotating platform has the plurality of concentric positioning grooves and a plurality of pairs of concentric electrically-conductive rings, each pair of electrically-conductive rings abutting against and being fixed to the inner walls and the outer walls of the positioning grooves respectively, whereas the two pairs of electrically-conductive resilient plates and the two resilient plate holders disposed on two opposing sides of the central axis respectively and corresponding in position to the positioning grooves respectively are disposed at the base. Therefore, the disclosure achieves more pairs of electrically-conductive rings and electrically-conductive resilient plates to form more electrical-conduction loops and thereby form uninterrupted circuit conduction and enhance the stability of electrical conduction.

Preferably, the electrically-conductive resilient plates each comprise the two resilient arms bent to be capable of protruding and pushing resiliently.

In a preferred embodiment, the concentric positioning grooves and the electrically-conductive rings of the lower rotating disk are in the number of three and three pairs respectively, with the electrically-conductive rings each extending upward to form three upper connection ends, whereas the resilient plate holders and the electrically-conductive resilient plates of the base are in the number of six and six pairs respectively.

The power supply portion is a power connector for connecting to an external power source to receive electric power, and the power output portion is a power socket for providing output electric power.

Therefore, a motor turntable barrier-free electrical-conduction structure of the disclosure provides multiple electrical-conduction loops to ensure the stability of circuit conduction and achieve barrier-free, uninterrupted electrical conduction in the course of rotation, enables a drive motor to operate in an indirect driving mode, provides a hollow-core passage at a central axis, provides supporting posts with a carrying and supporting function, but imposes no negative effect on the rotation of a rotating platform of the motor turntable, achieving a diverse application mode based on multiple rotary motors connected in series to enhance overall applicability.

Objectives, technical features, and advantages of the disclosure are herein illustrated with preferred embodiments, depicted with accompanying drawings, and described below.

### BRIEF DESCRIPTION OF THE SEVERAL VIEWS OF THE DRAWINGS

FIG. 1 is a perspective view of a motor turntable barrier-free electrical-conduction structure in a preferred embodiment of the disclosure.

FIG. 2 is an exploded view of the motor turntable barrier-free electrical-conduction structure in the preferred embodiment of the disclosure.

FIG. 3 is another exploded view of the motor turntable barrier-free electrical-conduction structure in the preferred embodiment of the disclosure.

FIG. 4 is a cross-sectional view of the motor turntable barrier-free electrical-conduction structure in the preferred embodiment of the disclosure.

FIG. 5 is an enlarged view of the motor turntable barrier-free electrical-conduction structure in the preferred embodiment of the disclosure.

FIG. 6 is a cross-sectional view of the motor turntable barrier-free electrical-conduction structure taken along line A-A of FIG. 4.

FIG. 7 is a schematic view of electrical connection in a rotating platform in a preferred embodiment of the disclosure.

FIG. 8 is a schematic view of electrical connection in a base in a preferred embodiment of the disclosure.

FIG. 9 is a schematic view of the application of the motor turntable barrier-free electrical-conduction structure in a preferred embodiment of the disclosure.

### DETAILED DESCRIPTION OF THE INVENTION

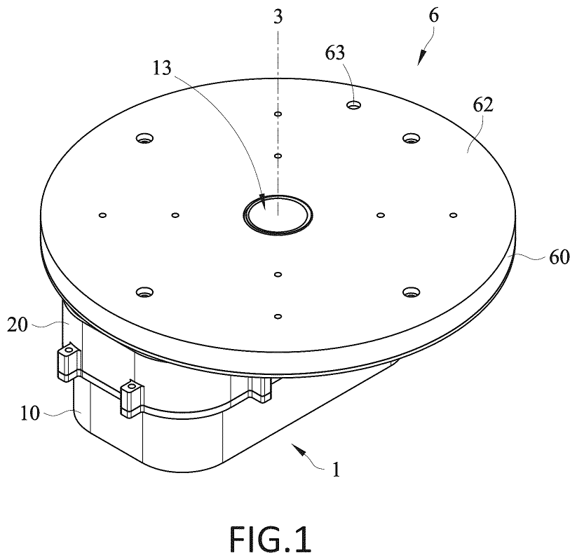

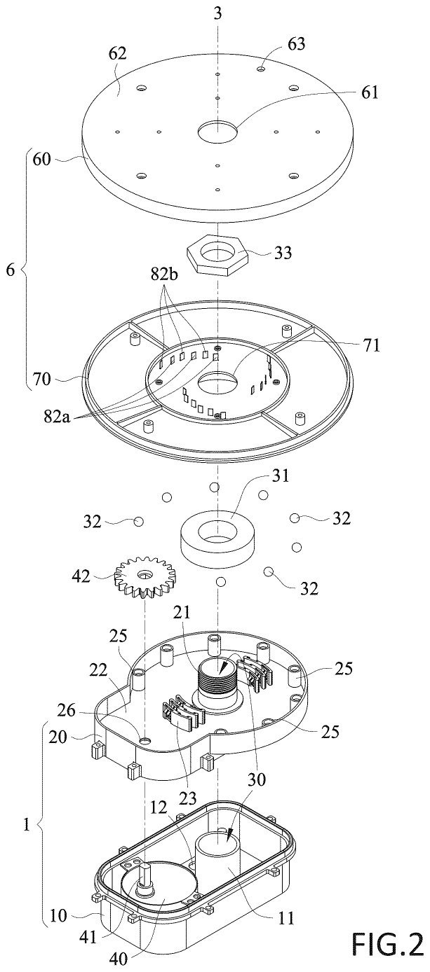

Referring to FIG. 1 and FIG. 2, an embodiment of the disclosure provides a motor turntable that essentially comprises a base 1 with a drive motor 40 and a rotating platform 6 disposed on the base 1. The rotating platform 6 is driven by the drive motor 40 to rotate about a central axis 3 on the base 1.

The rotating platform 6 essentially comprises an upper disk cover 60 and a lower rotating disk 70 coupled together. The upper disk cover 60 is above the lower rotating disk 70, with an appropriate space formed therebetween to facilitate the connection of circuit components. A platform surface 62 which an object can be placed on is formed on top of the upper disk cover 60, and also formed on top of the upper disk cover 60 is a power inlet 63 through which electric power is provided to the object. The lower rotating disk 70 is joined to the base 1 through an appropriate mechanism (, for example, a bearing unit 31 or an output rotating shaft 41 directly joined to the drive motor 40). In this embodiment, the base 1 comprises an underlying bottom casing 10 and an intermediate casing 20 disposed between the bottom casing 10 and the rotating platform 6. In practice, the casings of the base 1 are integrally formed and still have the same internal arrangement as disclosed in this embodiment.

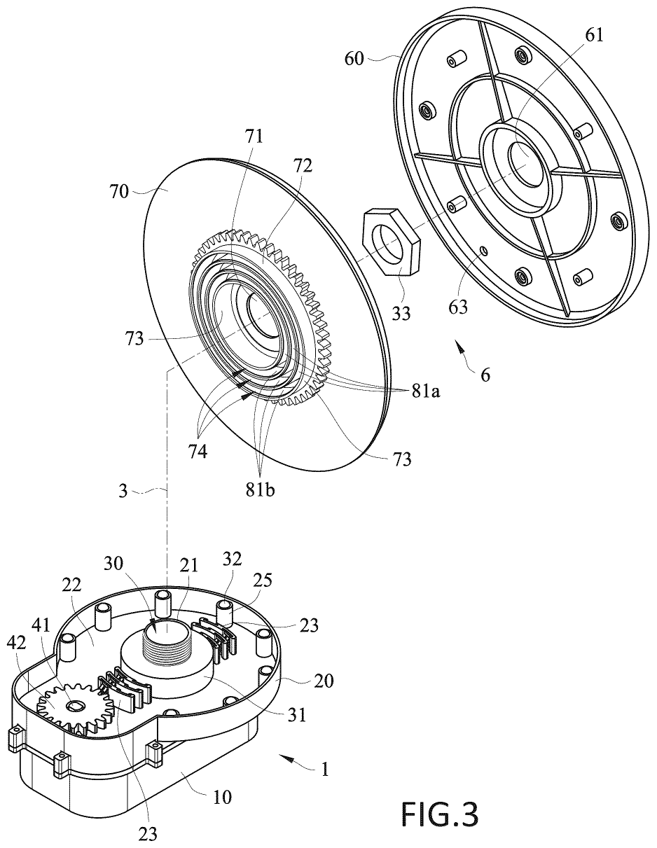

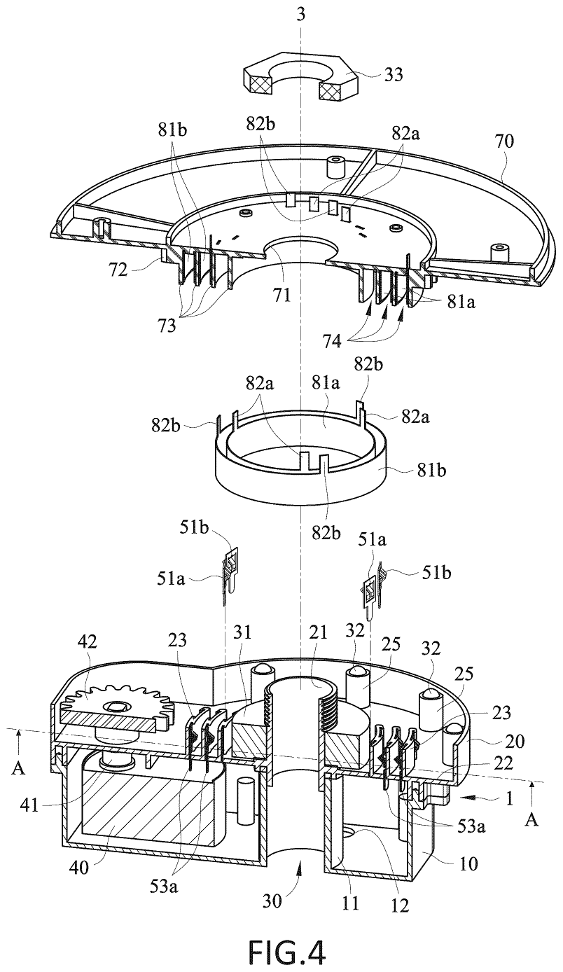

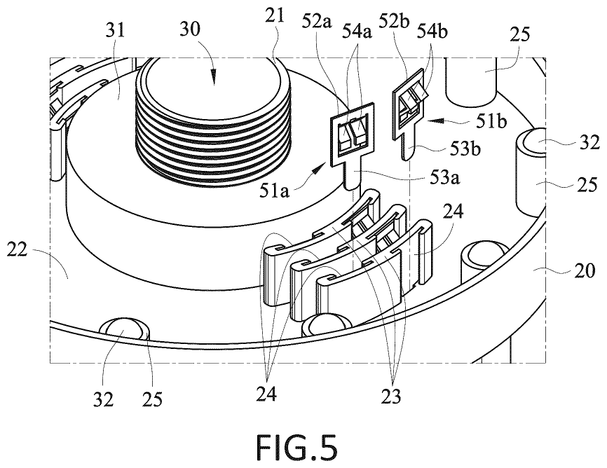

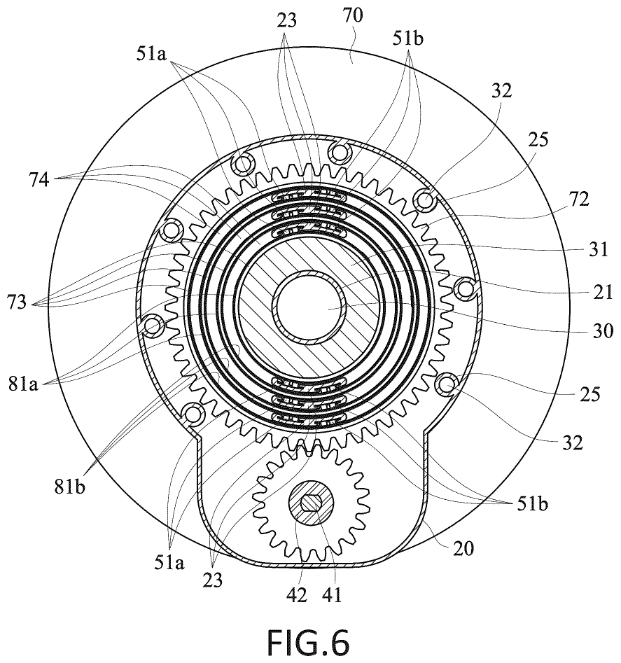

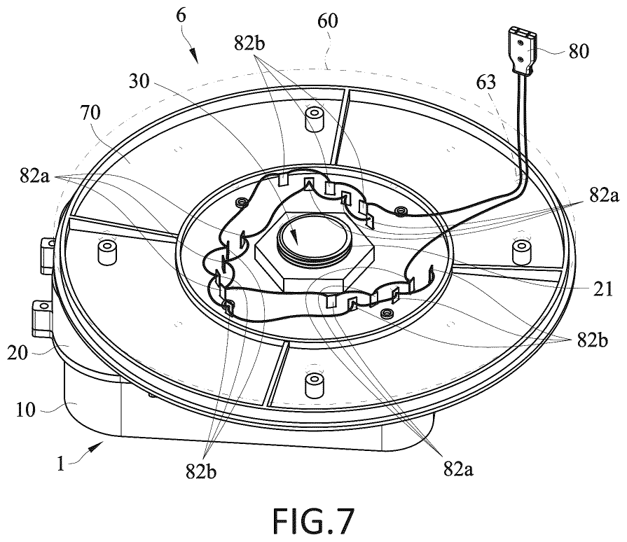

Referring to FIG. 3 through FIG. 6, an embodiment of the disclosure provides a rotary electrically-conductive structure essentially comprising a plurality of positioning grooves 74 and a plurality of pairs of electrically-conductive rings 81a, 81b disposed on the lower rotating disk 70 and extended radially from the central axis 3 toward the edge of the base 1. The positioning grooves 74 are ring-shaped and concentric. The electrically-conductive rings 81a, 81b are made of electrically-conductive sheets bent to become ring-shaped and concentric. Each pair of electrically-conductive rings 81a, 81b correspond in position to a corresponding one of the positioning grooves 74 and, in pairs, abut against and become fixed to the inner wall and outer wall of the corresponding one of the positioning grooves 74. For example, the electrically-conductive rings 81a abut against and become fixed to the inner walls of the positioning grooves 74, and the electrically-conductive rings 81b abut against and become fixed to the outer walls of the positioning grooves 74. The electrically-conductive rings 81a, 81b each extend upward to form a plurality of upper connection ends 82a, 82b (as shown in FIG. 4). The upper connection ends 82a, 82b pass through the lower rotating disk 70 and protrude from the lower rotating disk 70 to form end points disposed between the lower rotating disk 70 and the upper disk cover 60 and adapted for use in electrical connection. The upper connection ends 82a, 82b are electrically connected to a power output portion 80 of the rotating platform 6 (as shown in FIG. 7).

The base 1 has two resilient plate holders 23 which correspond in position to the positioning grooves 74 and can be inserted into the positioning grooves 74 respectively and two pairs of electrically-conductive resilient plates 51a, 51b. Every two resilient plate holders 23 corresponding in position to each positioning groove 74 are disposed on two opposing sides of the central axis 3 respectively. Each of two sides (i.e., two sides facing the inner wall and the outer wall of each of the positioning grooves 74 respectively) of each of the resilient plate holders 23 has a resilient plate slot 24 for fixing the electrically-conductive resilient plates 51a, 51b in place, as shown in FIG. 4 through FIG. 6, the resilient plate slots 24 facing the inner sides fix in place the electrically-conductive resilient plates 51a protruding inward respectively, and the resilient plate slots 24 facing the outer sides fix in place the electrically-conductive resilient plates 51b protruding outward respectively.

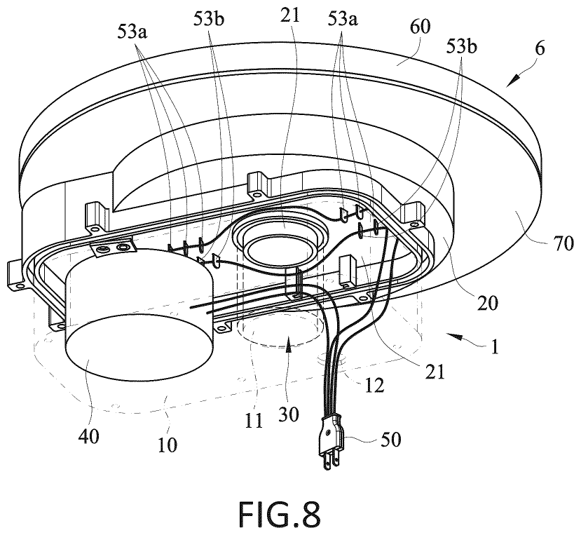

In this embodiment, the electrically-conductive resilient plates 51a, 51b comprise bodies 52a, 52b fixed in place in the resilient plate slots 24 respectively, each comprise two resilient arms 54a, 54b bent to resiliently protrude and push respectively, and comprise lower connection ends 53a, 53b extending downward from the bodies 52a, 52b respectively. Therefore, the electrically-conductive resilient plates 51a fixed in place in the resilient plate slots 24 facing the inner sides abut against the electrically-conductive rings 81a fixed to the inner walls through the resilient arms 54a resiliently protruding and pushing respectively, whereas the electrically-conductive resilient plates 51b fixed in place in the resilient plate slots 24 facing the outer sides abut against the electrically-conductive rings 81b fixed to the outer walls through the resilient arms 54b resiliently protruding and pushing respectively. The lower connection ends 53a, 53b are electrically connected to a power supply portion of the base 1 (as shown in FIG. 8).

Owing to the rotational electrical-conduction structure of the aforesaid embodiment, when the rotating platform 6 on the base 1 rotates, the electrically-conductive rings 81a, 81b rotate together with the rotating platform 6, and the electrically-conductive resilient plates 51a, 51b continuously abut against the electrically-conductive rings 81a, 81b through the resilient arms 54a, 54b respectively to form circuit conduction, allowing electricity to be freely transmitted from the base 1 to the rotating platform 6.

In a feasible embodiment, the drive motor 40 is disposed at an appropriate point on the base 1, for example, at the central axis 3, and the output rotating shaft 41 joined to the drive motor 40 is joined to the lower rotating disk 70 of the rotating platform 6, allowing the drive motor 40 to directly drive the rotating platform 6 rotating relative to the base 1. In this embodiment, the drive motor 40 is disposed in the base 1 and positioned beside the central axis 3, whereas the output rotating shaft 41 has a drive gear 42 that meshes with a wheel 72 at a bottom of the lower rotating disk 70. The drive motor 40 uses the output rotating shaft 41 to drive the drive gear 42 rotating and thereby cause the wheel 72 to drive the rotating platform 6 rotating, using a linkage mechanism to indirectly drive the rotating platform 6 rotating relative to base 1.

In this indirect drive structure, the base 1 has a hollow-core passage 30 at the central axis 3 and the axial bearing unit 31 annularly disposed around the hollow-core passage 30. The bearing unit 31, for example, provides balls bearing capable of axial load rotation, and its internal structure is a conventional, widely used means, and thus is, for the sake of brevity, not reiterated. The bearing unit 31 is essentially connected between the base 1 and the lower rotating disk 70 and adapted to not only abut against the rotating platform 6 but also enable the rotating platform 6 to smoothly rotate about the central axis 3 on the base 1.

In this embodiment, the hollow-core passage 30 of the base 1 is formed through the communication between a hollow-core tube 11 of the bottom casing 10 and a hollow-core tube 21 of the intermediate casing 20. The lower rotating disk 70 and the upper disk cover 60 have respectively hollowed-out central holes 71, 61 corresponding in position to the hollow-core passage 30. In an assembly process, the central holes 71, 61 of the lower rotating disk 70 and the upper disk cover 60 fit around the hollow-core tube 21 of the intermediate casing 20, and a positioning nut 33 is coupled to the hollow-core tube 21 to fix the lower rotating disk 70 of the rotating platform 6 in place to not only allow the lower rotating disk 70 to stay between the bearing unit 31 and the positioning nut 33 and rotate along the hollow-core tube 21 but also allow the rotating platform 6 to stay on the base 1 and rotate along the hollow-core tube 21, with the hollow-core passage 30 being still open while the rotation is taking place, providing diverse applications but bringing about no adverse effects despite the rotation of the rotating platform 6.

In this embodiment, the base 1 has a partition 22 corresponding in position to the intermediate casing 20 and adapted to divide internal space of the base 1. The partition 22 functions as a bottom board of the intermediate casing 20, allowing the partitioned space of the base 1 to be regarded as the space of the intermediate casing 20 and the space of the bottom casing 10 or the space above the partition 22 and the space below the partition 22. The resilient plate holders 23, the bearing unit 31 and the drive gear 42 are disposed in the intermediate casing 20. The bearing unit 31 is fitted around the hollow-core tube 21 and connected between the partition 22 and the lower rotating disk 70. The resilient plate holders 23 are disposed on two opposing sides of the hollow-core tube 21 respectively and correspond in position to the positioning grooves 74 respectively. The drive motor 40 is disposed in the bottom casing 10 and positioned beside the hollow-core tube 11. The output rotating shaft 41 of the drive motor 40 is penetratingly disposed at a motor axle hole 26 of the partition 22 and adapted to connect to and drive the drive gear 42.

The lower connection ends 53a, 53b extending downward from the electrically-conductive resilient plates 51a, 51b penetrate the partition 22 to reach the space of the bottom casing 10 (or the space below the partition 22 of the base 1). Referring to FIG. 4 and FIG. 8, the power supply portion 50 in the space of the bottom casing 10 is electrically connected to the lower connection ends 53a, 53b and the drive motor 40.

In this embodiment, to allow the rotating platform 6 to smoothly rotate on the base 1, not only does the bearing unit 31 abut against the rotating platform 6, but a plurality of spaced-apart ball positioning portions 25 and balls 32 are also annularly disposed at the intermediate casing 22, with the balls 32 received and positioned in the ball positioning portions 25 to abut against the bottom surface of the lower rotating disk 70 and coordinate with the bearing unit 31 to enhance overall carrying strength and rotational smoothness, allowing the rotating platform 6 to steadily and smoothly rotate about the central axis 3 on the base 1.

In this embodiment, the three concentric positioning grooves 74 and the three pairs of electrically-conductive rings 81a, 81b fixed therein, adapted to enable rotational electrical conduction, are disposed between the lower rotating disk 70 and the base 1. The electrically-conductive rings 81a, 81b each extend upward to form three isometrically distributed upper connection ends 82a, 82b. Three resilient plate holders 23 are disposed on each of the two opposing sides of the hollow-core passage 30, and thus the resilient plate holders 23 are in the number of six. Six pairs of electrically-conductive resilient plates 51a, 51b are disposed in the resilient plate holders 23. Therefore, the loop increase ensures the stability of circuit conduction, ensures the smoothness of rotation, and thereby renders electrical conduction barrier-free and uninterrupted in the course of rotation.

Regarding the assembly process in this embodiment, required parts and components are the same as those of the aforesaid structure, whereas circuit connection is shown in FIG. 7 and FIG. 8. In the internal space of the rotating platform 6, the protruding upper connection ends 82a (i.e., end portions raised upward from the electrically-conductive rings 81a fixed to inner surfaces of the positioning grooves 74) are connected by a conducting wire and then electrically connected to the power output portion 80, whereas the protruding the upper connection ends 82b (i.e., end portions raised upward from the electrically-conductive rings 81b fixed to outer surfaces of the positioning grooves 74) are connected by another conducting wire and then electrically connected to the power output portion 80, jointly forming positive- and negative-terminal conducting wires connected in parallel. The power output portion 80 is a power socket comprising a conducting wire penetratingly protruding out of the power inlet 63 and disposed on the rotating platform 6 or a power socket disposed at the power inlet 63 to supply electric power to products in a barrier-free manner while the rotating platform 6 is rotating.

In the lower space of the base 1, i.e., the internal space of the bottom casing 10 below the partition 22 (as shown in FIG. 8), the downward-protruding lower connection ends 53a (i.e., protruded downward end portions of the electrically-conductive resilient plates 51a abutting inward against the electrically-conductive rings 81a through the resilient arms 54a) are connected by a conducting wire and then electrically connected to the power supply portion 50, whereas the downward-protruding lower connection ends 53b (i.e., protruded downward end portions of the electrically-conductive resilient plates 51b abutting inward against the electrically-conductive rings 81b through the resilient arms 54b) are connected by another conducting wire and then electrically connected to the power supply portion 50, jointly forming positive- and negative-terminal conducting wires connected in parallel. The power supply portion 50 is a power connector comprising a conducting wire penetratingly protruding out of a power receiving opening 12 of the base 1 to connect to an external power source to receive electric power. Therefore, owing to the aforesaid circuit connection of the rotating platform 6, multiple loops are connected; thus, with just one or more loops, it is feasible to achieve electrical conduction, enable smooth rotation, and effectively ensure the stability of overall barrier-free electrical conduction.

In another feasible embodiment, the upper connection ends 82a, 82b corresponding in position to three pairs of electrically-conductive rings 81a, 81b are electrically connected to the three power output portions 80 respectively, whereas in the base 1 the two pairs of electrically-conductive resilient plates 51a, 51b corresponding in position to each pair of electrically-conductive rings 81a, 81b are electrically connected to the power supply portions 50 respectively, and thus the base 1 has three power supply portions 50; thus, three power supply modes are formed, dispensing with the need to provide an additional complicated control circuit for regulating different electrical apparatuses. Therefore, the barrier-free electrical-conduction structure of the disclosure is fully applicable to one, two, three or even more power supply applications, exhibiting high applicability.

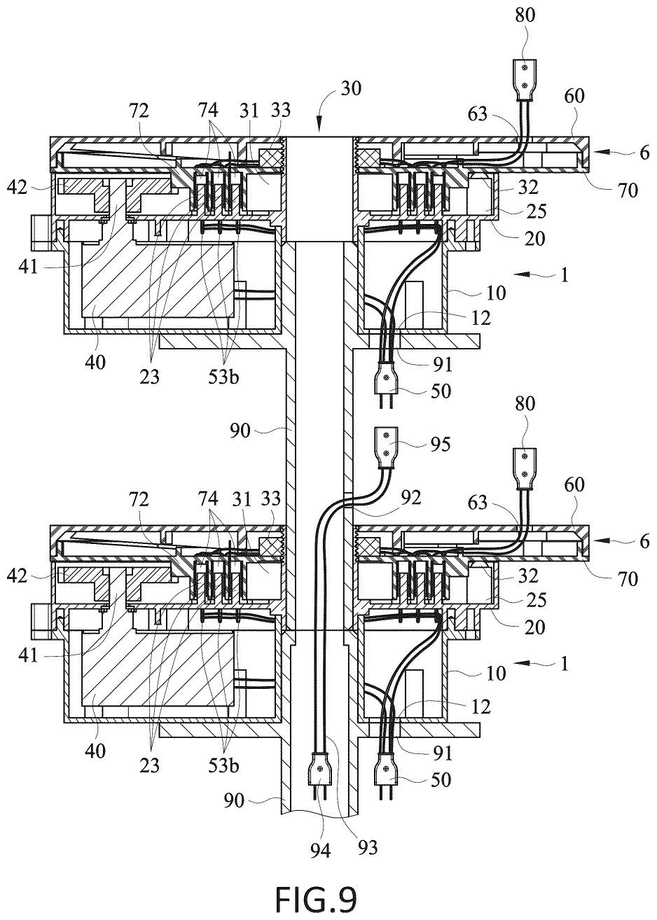

In this embodiment, as illustrated by FIG. 9, a carrying support 90 with an upright post is penetratingly disposed in the hollow-core passage 30, with holes 91, 92 adapted for wiring connection disposed at an appropriate point on each carrying support 90, and a power extension component 93 with a power receiving portion 94 and a power supplying portion 95 provides hidden circuit supply to form a diverse mode capable of connecting several motor turntables in series, prevent the rotation of the rotating platform 6 of each motor turntable from conflicting with the hollow-core passage 30 and the carrying support 90, allow the rotating platform 6 to rotate smoothly in a series-connected state, enable barrier-free power supply to take place on the rotating platform 6, and allow the motor turntables to have wide application.

The disclosure is disclosed above by preferred embodiments. All extensions, modifications, simple changes and equivalent replacements made to the preferred embodiments according to the technical features of the disclosure shall fall within the scope of the claims of the disclosure.

What is claimed is:

1. A motor turntable barrier-free electrical-conduction structure, comprising:
a base with a drive motor; and
a rotating platform disposed on the base and driven by the drive motor to rotate about a central axis on the base,
wherein the rotating platform comprises a lower rotating disk and an upper disk cover coupled together, and a platform surface which an object can be placed on is formed on top of the upper disk cover, allowing at least one pair of concentric electrically-conductive rings and at least one ring-shaped positioning groove concentric about the central axis to be disposed on the lower rotating disk and face the base, allowing the pair of electrically-conductive rings to abut against and be fixed to an inner wall and an outer wall of the positioning groove respectively, with the electrically-conductive rings each extending upward to form at least one upper connection end disposed penetratingly at the lower rotating disk and disposed between the lower rotating disk and the upper disk cover to electrically connect to a power output portion of the rotating platform,
wherein at least one resilient plate holder corresponding in position to the positioning groove and inserted into the positioning groove and at least one pair of electrically-conductive resilient plates are disposed at the base, a resilient plate slot for fixing the electrically-conductive resilient plates in place are disposed on each of two sides of the resilient plate holder respectively, the two sides facing the inner wall and the outer wall of the positioning groove respectively, the electrically-conductive resilient plates each comprising a body fixed in place in a corresponding one of the resilient plate slots and at least one resilient arm resiliently abutting against a corresponding one of the electrically-conductive rings, the body having a lower connection end electrically connected to a power supply portion of the base,
wherein the at least one pair of electrically-conductive rings rotate together with the rotating platform while the rotating platform is rotating on the base, and the at least one pair of electrically-conductive resilient plates continuously abut against the electrically-conductive rings through the resilient arms respectively to form circuit conduction, allowing electricity to be freely transmitted from the base to the rotating platform.

2. The motor turntable barrier-free electrical-conduction structure of claim 1, wherein the base has the two resilient plate holders and the two pairs of electrically-conductive resilient plates which correspond in position to the positioning grooves, and the two resilient plate holders are disposed on two opposing sides of the central axis respectively.

3. The motor turntable barrier-free electrical-conduction structure of claim 2, wherein the electrically-conductive rings are made of electrically-conductive sheets bent to become ring-shaped and concentric, and the electrically-conductive rings extend upward to form a plurality of upper connection ends.

4. The motor turntable barrier-free electrical-conduction structure of claim 3, wherein the drive motor is disposed beside the central axis and comprises an output rotating shaft and a drive gear disposed on the output rotating shaft, the drive gear meshing with a wheel at a bottom of the lower rotating disk, allowing the drive motor to drive the drive gear rotating and thereby cause the wheel to drive the rotating platform rotating.

5. The motor turntable barrier-free electrical-conduction structure of claim 4, wherein the base has a hollow-core passage at the central axis and an axial bearing unit annularly disposed around the hollow-core passage and adapted to abut against the lower rotating disk of the rotating platform to enable the rotating platform to rotate about the central axis on the base, wherein the lower rotating disk and the upper disk cover of the rotating platform each have a hollowed-out central hole corresponding in position to the hollow-core passage.

6. The motor turntable barrier-free electrical-conduction structure of claim 5, wherein the base comprises an underlying bottom casing and an intermediate casing disposed between the bottom casing and the rotating platform, wherein the bottom casing and the intermediate casing each have a hollow-core tube corresponding in position to the central axis, and the two hollow-core tubes are in communication with each other to form the hollow-core passage.

7. The motor turntable barrier-free electrical-conduction structure of claim 6, wherein the intermediate casing comprises a partition for dividing internal space of the intermediate casing and the bottom casing, wherein the bearing unit, the resilient plate holders and the drive gear are disposed in the intermediate casing, and the drive motor is disposed in the bottom casing, allowing the output rotating shaft of the drive motor to penetrate the partition to connect to and drive the drive gear.

8. The motor turntable barrier-free electrical-conduction structure of claim 7, wherein the bodies of the electrically-conductive resilient plates extend downward to form the lower connection ends, with the lower connection ends penetrating the partition and disposed in the internal space of the bottom casing, and in the bottom casing the power supply portion is electrically connected to the lower connection ends and the drive motor.

9. The motor turntable barrier-free electrical-conduction structure of claim 8, wherein a plurality of spaced-apart ball positioning portions surround the bearing unit in the intermediate casing and each receive a ball abutting against a bottom surface of the lower rotating disk and coordinating with the bearing unit to enable the rotating platform to rotate about the central axis on the base.

10. The motor turntable barrier-free electrical-conduction structure of claim 9, wherein the lower rotating disk of the rotating platform has the plurality of concentric positioning grooves and a plurality of pairs of the concentric electrically-conductive rings, each pair of the electrically-conductive rings abutting against and being fixed to the inner walls and the outer walls of the positioning grooves respectively, wherein the two pairs of electrically-conductive resilient plates and the two resilient plate holders disposed on two opposing sides of the central axis respectively and corresponding in position to the positioning grooves respectively are disposed at the base.

11. The motor turntable barrier-free electrical-conduction structure of claim 10, wherein the electrically-conductive resilient plates each comprise the two resilient arms bent to be capable of protruding and pushing resiliently.

12. The motor turntable barrier-free electrical-conduction structure of claim 11, wherein the concentric positioning grooves and the electrically-conductive rings of the lower rotating disk are in the number of three and three pairs respectively, with the electrically-conductive rings each extending upward to form three upper connection ends, wherein the resilient plate holders and the electrically-conductive resilient plates of the base are in the number of six and six pairs respectively.

13. The motor turntable barrier-free electrical-conduction structure of claim 12, wherein the power supply portion is a power connector for connecting to an external power source to receive electric power, and the power output portion is a power socket for providing output electric power.

14. The motor turntable barrier-free electrical-conduction structure of claim 1, wherein the drive motor is disposed beside the central axis and comprises an output rotating shaft and a drive gear disposed on the output rotating shaft, the drive gear meshing with a wheel at a bottom of the lower rotating disk, allowing the drive motor to drive the drive gear rotating and thereby cause the wheel to drive the rotating platform rotating.

15. The motor turntable barrier-free electrical-conduction structure of claim 14, wherein the base has a hollow-core passage at the central axis and an axial bearing unit annularly disposed around the hollow-core passage and adapted to abut against the lower rotating disk of the rotating platform to enable the rotating platform to rotate about the central axis on the base, wherein the lower rotating disk and the upper disk cover of the rotating platform each have a hollowed-out central hole corresponding in position to the hollow-core passage.

16. The motor turntable barrier-free electrical-conduction structure of claim 15, wherein the lower rotating disk of the rotating platform has the plurality of concentric positioning grooves and a plurality of pairs of the concentric electrically-conductive rings, each pair of the electrically-conductive rings abutting against and being fixed to the inner walls and the outer walls of the positioning grooves respectively, wherein the two pairs of electrically-conductive resilient plates and the two resilient plate holders disposed on two opposing sides of the hollow-core passage respectively and corresponding in position to the positioning grooves respectively are disposed at the base.

17. The motor turntable barrier-free electrical-conduction structure of claim 16, wherein the base comprises a partition for dividing internal space, wherein the bearing unit, the resilient plate holders and the drive gear are disposed above the partition, and the drive motor is disposed below the partition, with the output rotating shaft penetrating the partition to connect to and drive the drive gear, wherein the bodies of the electrically-conductive resilient plates extend downward to form the lower connection ends, with the lower connection ends penetrating the partition and disposed below the partition, and below the partition the power supply portion is electrically connected to the lower connection ends and the drive motor.

18. The motor turntable barrier-free electrical-conduction structure of claim 17, wherein a plurality of spaced-apart ball positioning portions surround the bearing unit in the base and each receive a ball abutting against a bottom surface of the lower rotating disk and coordinating with the bearing unit to enable the rotating platform to rotate about the central axis on the base.

19. The motor turntable barrier-free electrical-conduction structure of claim 18, wherein the electrically-conductive rings are made of electrically-conductive sheets bent to become ring-shaped and concentric, and the electrically-conductive rings extend upward to form a plurality of upper connection ends.

20. The motor turntable barrier-free electrical-conduction structure of claim 19, wherein the electrically-conductive resilient plates each comprise the two resilient arms bent to be capable of protruding and pushing resiliently.
